(19) United States
(12) Patent Application Publication
(10) Pub. No.: US 2006/0195542 A1
(43) Pub. Date: Aug. 31, 2006

(54) Method and system for determining the probability of origin of an email

(76) Inventor: Ian R. Nandhra, Sonora, CA (US)

Correspondence Address: BEYER WEAVER & THOMAS, LLP, P.O. BOX 70250, OAKLAND, CA, 94612-0250, US

(21) Appl. No.: 10/565,355

(22) PCT Filed: Jul. 23, 2004
(86) PCT No.: PCT/US04/23934

§ 371 Date: Jan. 20, 2006

Related U.S. Application Data
(60) Provisional application No. 60/489,655, filed on Jul. 23, 2003.

(51) Int. Cl. G06F 15/16

(52) U.S. Cl. 709/207

(57) ABSTRACT

A system, method and apparatus providing for characterizing e-mails to aid in the identification of masqueraded emails and the classification of email content in a distributed and non-distributed environment. Mechanisms are provided to facilitate the sharing of email data and such other data such as SPAM and email content classification data as is required. Improved mechanisms are also provided to merge pluralities of lists of such data.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A COMPACT DISK APPENDIX

Not applicable.

### BACKGROUND OF THE INVENTION

The present invention relates to a method of characterizing a received email such that the recipient of the email can better determine what actions to perform on the email. For example, the present invention also relates to a method of determining the probability that the email has actually been sent from a specified email address.

Users of email are familiar with the concept of “SPAM”, a term used to describe unwanted and unsolicited email. SPAM has become a significant problem for email users and the networks over which email is sent. Statistics on SPAM as a percentage of all email traffic are periodically published and while the accuracy of such statistics can be difficult or impossible to verify, SPAM clearly has a significantly undesirable impact.

There are many commercial products, technologies and techniques that claim to reduce SPAM. For example, such techniques involve:
Private and shared databases containing details of computers, domains and email addresses known to send SPAM.
The use of historical data (sometimes known as a corpus)
Bayesian and other deterministic statistical techniques used to filter out SPAM (or supposedly unwanted) email. The filters are open to exploits by originators of SPAM.

Although in widespread use, such techniques suffer from significant problems, examples being:
The data comprising the corpus is historical by nature may be old such that it does not accurately characterize the SPAM currently being received.
The data in the corpus requires periodic updating to remove the now irrelevant content and seldom used content that may otherwise interfere with the characterization of new content.
The Bayesian techniques will result in the false identification of SPAM and the failure to detect a wanted email.
The failure to analyze emails that comprise pictures or other graphical elements. SPAM emails frequently use graphical and pictorial elements to convey their message.
The failure to define the nature and meaning of SPAM, wanted and unwanted emails.
Different users of similar interests cannot share their corpus data

Perhaps the most serious drawback is the definition of “SPAM”. Email recipients will have different and highly subjective definitions of what a “wanted” and “unwanted” email will comprise. Techniques that learn “good” words and terms from texts define “unwanted” words and terms as those are not “good” and thus fail to identify the larger quantities of words and texts that are “of no present interest”.

Deterministic techniques such as Bayesian filters are characterized by a “convergence point” where it is difficult to determine if an email is “wanted” or “unwanted” (i.e, SPAM). The convergence point typically increases the likelihood of identifying a wanted email as SPAM (known in the art as a “false positive”). Conversely, the failure to identify an email as SPAM is known as a “false negative”. Defining the nature of the convergence point is almost entirely subjective to the needs of the specific user at the time the email is received. Originators of SPAM contrive their content to exploit the shortcomings of such filtering techniques and to exploit the “convergence point” to produce “false negatives” from filtering techniques that might be used. Additionally, techniques often define “wanted” emails as being those that “are not SPAM” and clearly fail to identify emails that are “not wanted” because they are of no present interest rather than being SPAM.

Since consequences of “false positives” are entirely subjective to the needs of the specific user at the time the email was received and since the consequences of doing otherwise could be serious, there is a bias towards the identification of “false negatives” than “false positives”. The decrease of false positives (the misidentification of an email wanted by the user as SPAM) results in a corresponding increase in false negatives (the misidentification of a SPAM email as being a wanted email).

Another major problem for email users is the increasingly common technique of email masquerading, a practice whereby an originator of an email pretends to be someone else. Those versed in the art are well aware that it is possible for almost any email user, to send email from g.w.bush@whitehouse.gov and that recipients of such email might indeed believe that it has come from a Mr G. W. Bush. Such practice might be illegal in the geographical location the email originated and legal in the geographical location it is received. Conversely, it might be legal in the geographical location it is sent and illegal in the geographical location it is received. Even if it is illegal in the destination geographical location, the number of different paths through different geographical locations will complicate any action that can be taken even if the originator can be identified. Proving the identity of an email sender is more difficult if there is no other form of contact or evidence. For example, David Bowie, a well-known singer of popular contemporary music is said to have entered a “David Bowie Impersonators” contest at a popular resort where he “won” third place. The judges of the contest, having to rely on appearance alone, did not consider the real David Bowie to be genuine. Similarly, email users often have to rely entirely on a received email as evidence that it is genuine.

Email masquerading is increasingly being used to spread computer viruses, SPAM and especially fraudulent attempts to get personal information such as credit card numbers and addresses. Indeed, the media frequently report cases where email masquerading has been used to successfully harvest credit card information from large numbers of account holders.

Clearly some masqueraded email recipients will recognize that they are suspicious and will make further investigations. However, as evidenced from the media reports, such recipients consider such emails to be genuine. FIG. 1 shows an example of such an email. Although seemingly from ebay.com (100), a popular auction web site on the Internet, it originated from “ASPADMIN.COM”, a site other than eBay. The url address (104) contained within the email test, although referencing the real ebay.com site, pointed to a web page in Romainia (102) that requested significant amounts of personal and financial information in a manner representative of a real ebay.com page. To the detriment of email users, current SPAM identification techniques do not address the serious threat posed by email masquerading.

Detecting a masqueraded email relies heavily on usage and behavior of specific individuals that in turn makes Bayesian style techniques more error prone.

Clearly a system that enhanced the reliability of detecting wanted emails and also detecting masqueraded emails would be beneficial to email users and the organizations that deliver email. Combining similar usage and behavior of a plurality of email users would further enhance detection reliability consequently reducing false positives and false negatives.

The problems posed by “false negatives” and “false positives” are popularly addressed by a practice known in the art as “white lists” and “black lists”. “White list” describes storage containing the email address of those trusted not to send spam and “black list” describes storage containing the email address of those who are known to send SPAM. However, these lists rely on knowing that a particular email address is not being masqueraded, since the addition of a masqueraded address into either store could cause serious problems. For example, if a user receiving a SPAM email from another masquerading as the address “newsdesk@newspaper.com” and added the aforementioned address to a black list, the user might never receive email from that address again. Clearly without the means to validate the source of the SPAM email, the user has incorrectly added newsdesk@newspaper.com to the blacklist. In another example, a user receives an email from someone they know and adds them to a white list, removing a significant level of protection against the sender's computer sending out unwanted emails as a result of, for example, contracting a virus. Computer viruses may send masqueraded emails. Considering that SPAM prevention organizations maintain “black lists” that often contain large numbers of email addresses, a means of validating that these addresses have actually been used to send SPAM would be of benefit to such organizations and genuine senders of email. Clearly such “white lists” and “black lists” suffer from significant and serious drawbacks.

### BRIEF DESCRIPTION OF THE DRAWINGS

FIG. 1 is a real example of a masqueraded email

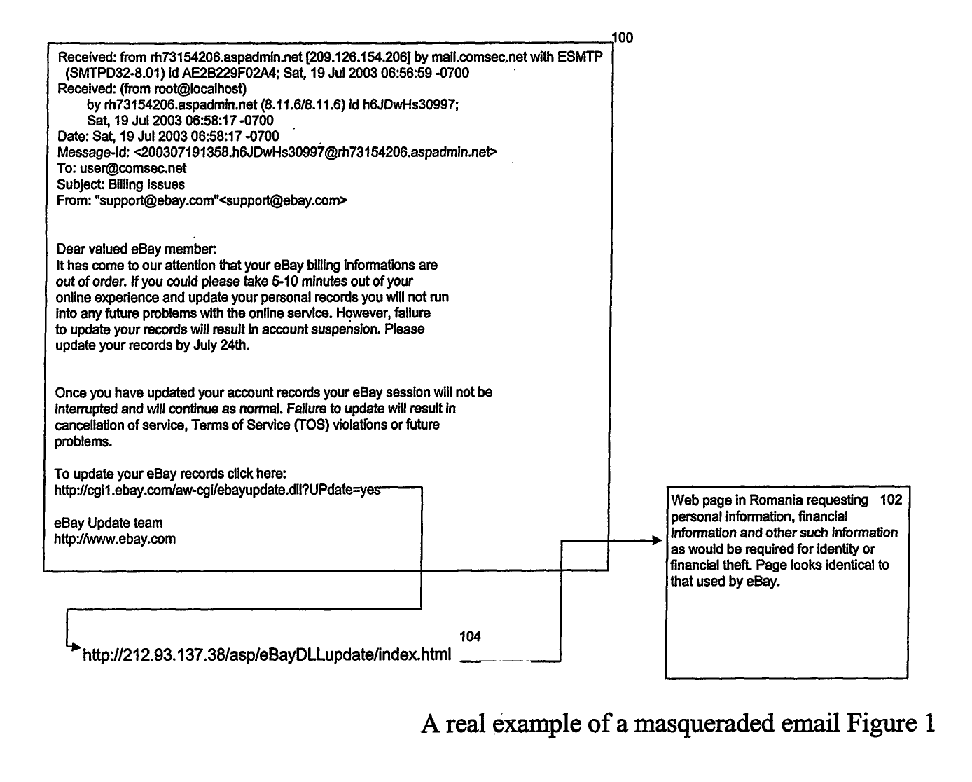

FIG. 2 is an example email path

FIG. 3 is an example of masqueraded email paths

FIG. 4. Path information lists

FIG. 5. Root Word

FIG. 6. Distributed Word Stores

FIG. 7. Distributed shared Corpora

FIG. 8. Distributed Corpora

FIG. 9. Example embodiment

### DETAILED DESCRIPTION OF THE INVENTION

In accordance with one broad aspect, a mechanism is provided to analyze the path an email took from its source to its destination and share such analysis with other users in a networked and distributed Space environment.

In accordance with another broad aspect, a mechanism is provided to use the path that an email took from its source to its destination to determine a probability that the aforementioned email has actually been sent from the email address described by the emails “from” address.

In accordance with another broad aspect, a mechanism is provided to characterize the textual content of email and share these characterizations (such as categories) with other characterizations in a networked and distributed Space environment.

In accordance with another broad aspect, a mechanism is provided to categorize the textual content of email and merge these categorizations with other categories in a networked and distributed Space environment.

As used herein, the term Synchronizer is meant broadly and not restrictively, to include any device or machine capable of accepting data, applying processes to the data, and supplying results of the processes. As used herein, the term “Storage” is meant broadly and not restrictively, to include a storage area for the storage of computer program code and for the storage of data and could be in the form of magnetic media such as floppy disks or hard disks, optical media such as CD-ROM or other forms.

In accordance with one broad aspect, a mechanism is provided to determine that a received email has not been forged or masqueraded by analyzing the path the email took to reach a destination in addition to comparing it with email previously received from the same sender. Received email contains information describing the path it has taken to reach its destination that in addition to other information contained within the aforementioned email provides a distinctive fingerprint that often does not change between subsequent emails, providing a recognition mechanism. For example, a user will send email from a particular email source path or from a particular source path taken from a plurality of source paths. There may be no limit to the number of source paths and no constraint on the selection of a particular source path from those available, but in common practice email from a particular user will originate from a small plurality of source paths or a particular source path. For example, email sent from sales@findbase.com will always come from the same source path or the same plurality of source paths giving the recipient a progressively higher probability that it a particular received email is genuine if it has come from one of the aforementioned source paths. Conversely, email received from a source path other than the previously encountered source paths will have a lower probability that it is genuine.

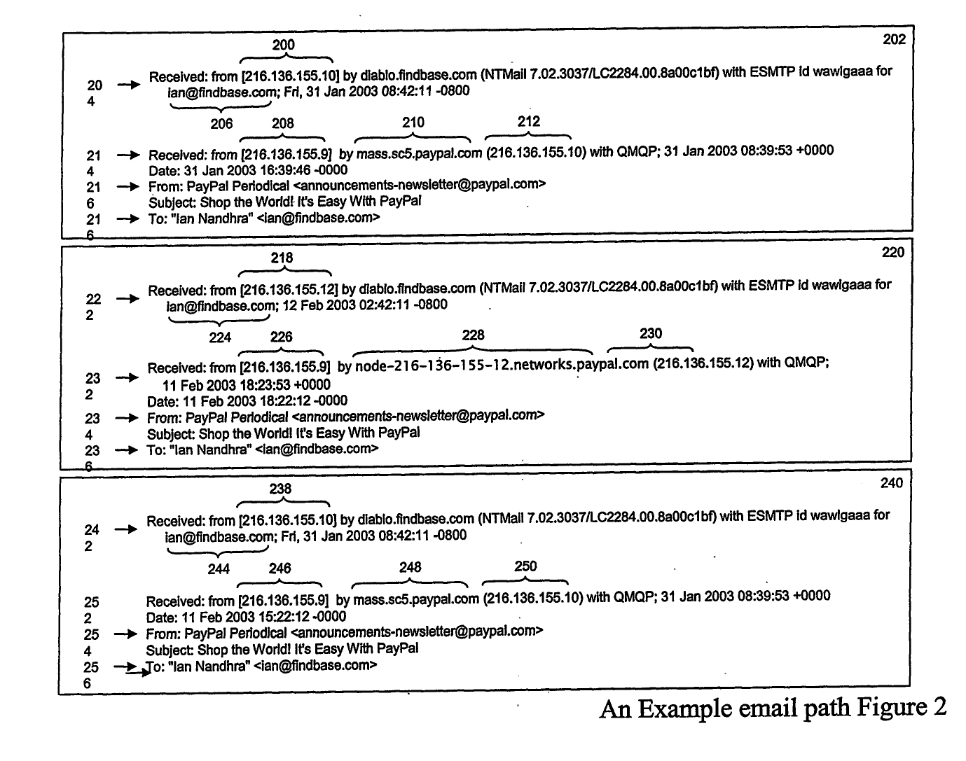

With reference to FIG. 2, we see the complete path (214, 204) taken by an example email from its source 216 to its destination 246. Drawing attention to information 214 describing the path of the email, a device such as a Personal Computer with an IP address 208 receives email from the sender 216, which is then sent to a receiver of name 210 and IP address 212. The information contained in the path 214 may vary significantly between embodiments and such differences are normal and should be expected. A receiver 200 receives the aforementioned email from 212 and sends it to its destination 206. Although specific system names (210), IP addresses (208, 212 and 200) have been shown, other emails sent by other systems may have different system names and IP addresses and may contain less or more information consistent with the needs of the specific embodiments and such system names, IP addresses, specific paths and information should not be considered restricted to those used in this example.

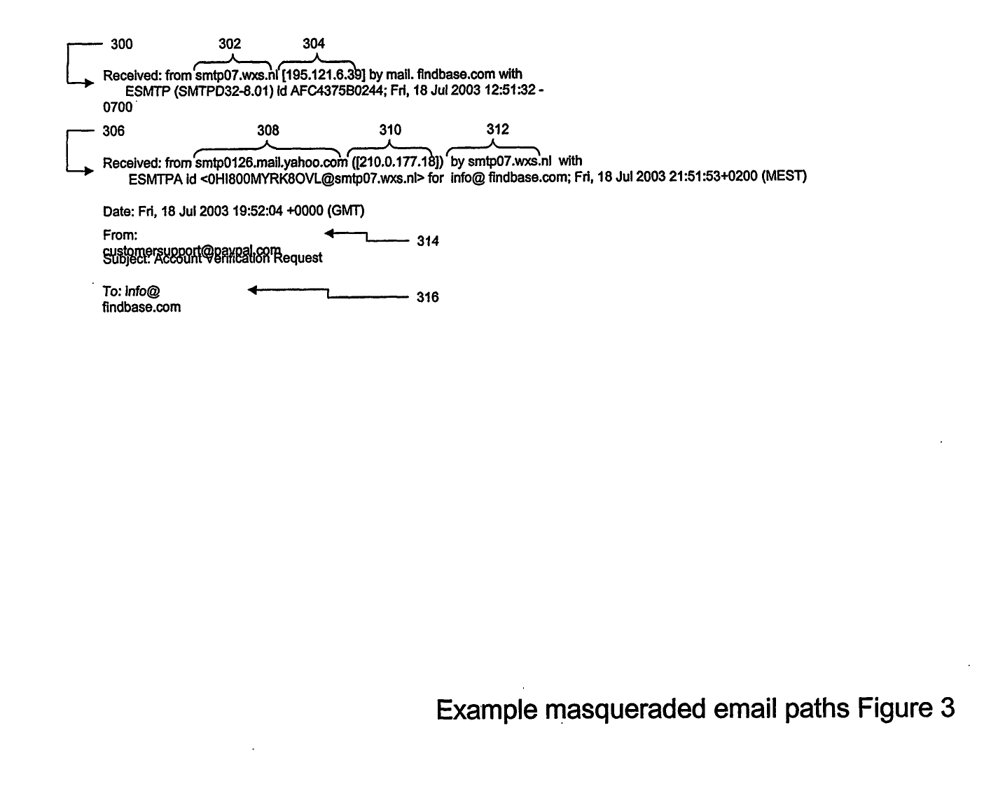

The path information (214, 204) can be maliciously altered at any stage as a particular email is sent from source to destination, such that proving the reliability or validity of such information as may appear in the path may be impossible. For example, with reference to FIG. 3, it can be seen that the email originator's domain 314 (paypal.com) does not match the domain (yahoo.com) of the receiver 308. Admittedly, it might be possible that customersupport@paypal.com (314) is really sending email through yahoo.com (308, 310), but further examination of the path 308 shows that the email is received by a system (312) with a domain name of “wxs.nl” which is in the geographical region known as The Netherlands whereas PayPal is in fact located in the State of California, USA. Referring back to FIG. 2 another example email 220 is received by a system with IP 226 from a.user 234. Particular attention is drawn to source of the email (234) is the same as the source 216 previously described in email 202. In this example (220) the email is received by a system (228, 230) that is different from the receiver (210, 212) of email 202. Particular attention is drawn to the identical domain names (paypal.com) in systems 210 and 228. With reference to email 240, we see that the path that the email takes from its source (254) to its destination (244) is identical to that in the example email 202.

The format of the information 204, 214, 222, 232, 242, 252 describing the email path may vary between embodiments, but is it commonplace for embodiments to provide information describing where the email has been received and where it has been sent.

Comparing path information 204, 214, 222, 232, 242, 252 with the path information 300, 306 in FIG. 3 would reveal that there is a low probability that email from 314 originated from source 308, 310 since previously encountered email from the sender 216, 234, 254 has come from the domain paypal.com (202, 220, 240). For further clarification, the email 314 is purportedly from a paypal.com domain but was received by systems 308, 310 other than a system in the paypal.com domain as previously encountered in 202, 220 and 240.

We now return attention to the path 214 in FIG. 2 and in particular the name 210 and the IP address 212. Performing a procedure known as a “dns lookup” on the IP address 212 yields a name identical to that of 210. Conversely, the IP address of the name 210 can be determined by other procedures such as “ns lookup” or “name server lookup”. The information returned by such procedures as “dns lookup” and “ns lookup” vary between the various embodiments of the procedures and may also vary between the different names (for example 210) and IP addresses (for example 212). Such differences are commonplace and should be expected. For example, a plurality of names can point to the same IP: a “ns lookup” on mail43.fmdbase.com could give the IP address 207.212.98.200 while “dns lookup” of which yields the name mail.findbase.com. Closer examination shows that both mail32.findbase.com and mail.findbase.com have the same domain name (findbase.com) and that the geographical information for the IP 207.212.98.200 refers to the findbase.com domain and the FINDbase as an organization.

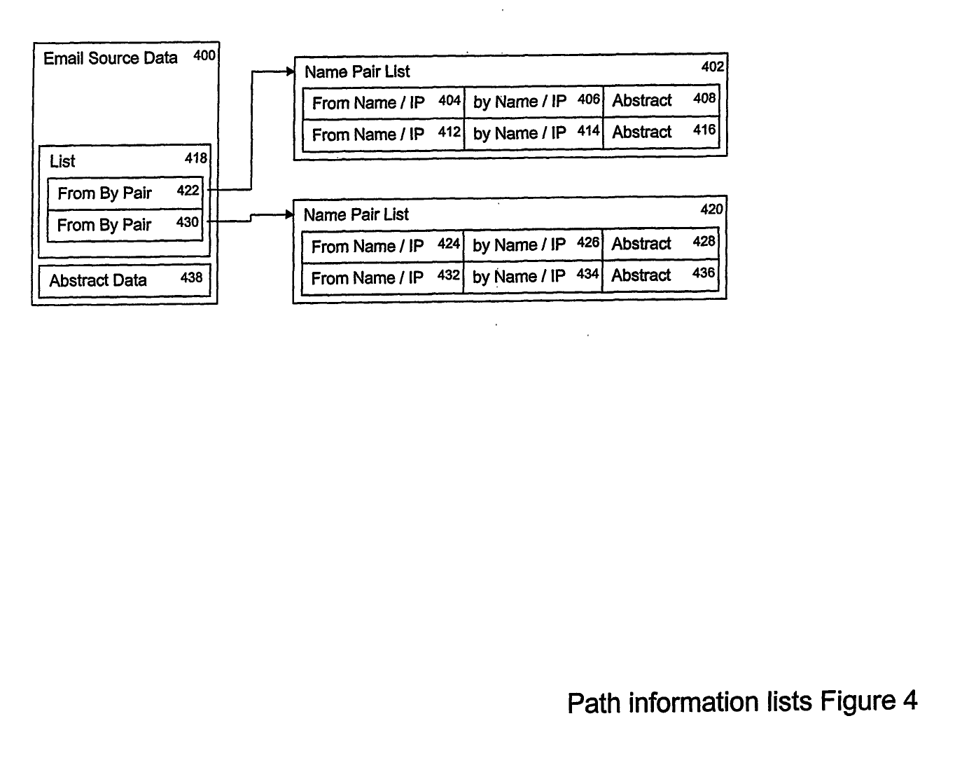

With reference to FIG. 4, a particular email source 410 references a list 418 of email paths 422,430 and abstract data 438 describing such additional information as may be used by specific embodiments. Each element of the list 418 describes in entirety or in part each unique path 402, 420 that email has taken from its source 410 to its destination. For example and with further reference to FIG. 2, the name pair list 402 contains the information described by the paths 204 and 214 such that 404 contains the information in 200, 412 contains the information in 208 and 414 contains the information in 210 and 212. The name pair list 420 contains the information described by the paths 222 and 232 such that 424 contains the information in 218, 432 would contain the information in 226 and 434 contains the information in 228 and 230. Such other information used by specific embodiments is contained in 408, 416, 428 and 436 respectively. In some preferred embodiments this information would comprise a total number of times email had been received using this path and data recording the time of all such instances. In no way should the data stored in the Email Source Data 400 and the Name Pair Lists 402 be considered restricted to that used in these examples.

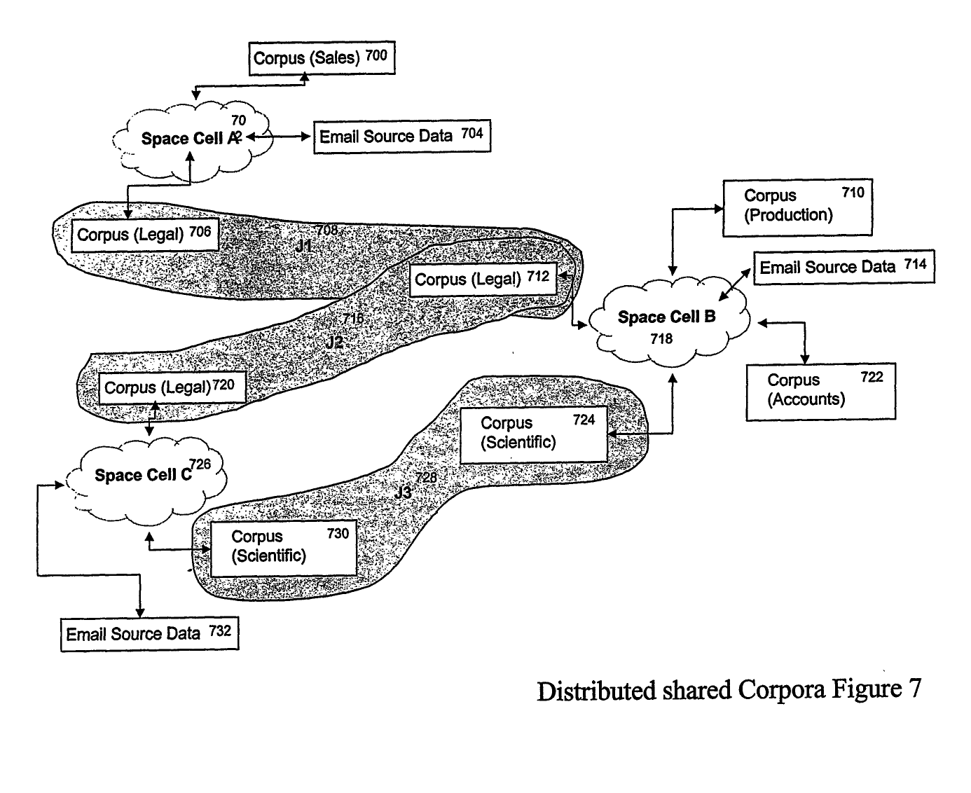

Some embodiments combine the information contain in a plurality of Email Source Data (400) across networks and distributed space environments as shown in FIGS. 7, 8 and 9 and discussed with reference to those figures in later sections.

Attention is now turned to another broad aspect of the present invention that improves the way that email is categorized into categories as may be used for example, to identify SPAM or other unwanted email. Such categorizations are often performed by deterministic measures (an example of which being Bayesian filters) although the present invention should be in no way considered limited to such filters. For example, one embodiment uses a simple statistical deterministic categorization. In another embodiment, a frequency histogram of word usage is used. Embodiments use artificial intelligence and adaptive storage methods to ensure that the word usage remained relevant to the email received by a particular user, their interests and word usage. While this aspect is discussed in terms of categorization, it's noted that, broadly, the e-mails may be considered to be characterized and based on the characterization, categorized as discussed herein. In some sense, the discussion of categorization may be considered a shorthand for such characterization and categorization.

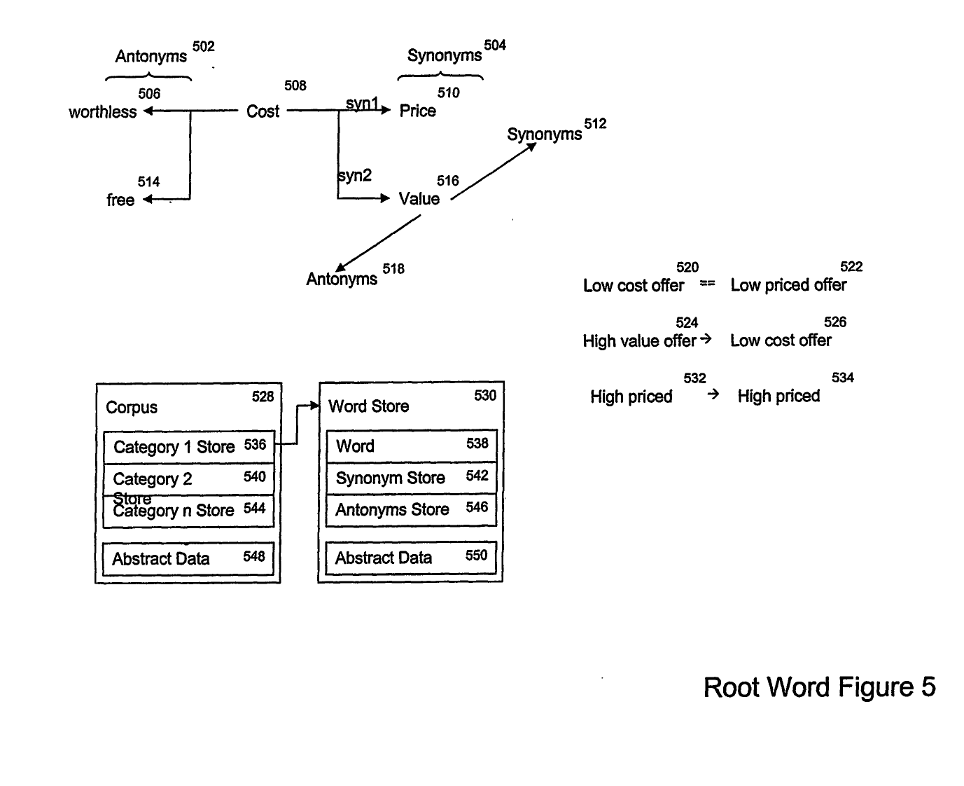

With reference to www.dictionary.com, a popular source of word definitions on the Internet, the word “cost” has synonyms “price” and “value”, although other synonyms are possible and should be expected. With reference to FIG. 5, the root word “cost” 508 has synonyms “price” 510, “value” 516 and antonyms “free” 514 and “worthless”, 506. Each of the antonyms and synonyms may themselves have respective antonyms 502 and synonyms 504, the number of such antonyms and synonyms is dependent on the specific context of the particular word and the needs of the specific embodiments. Designating the word “cost” as a root word, the synonyms 510 and 516 are assigned a value representing the distance “syn1” and “syn2” from the root word 508. Antonyms 506 and 514 are assigned distance values “anti” and “ant2”. The nature and meaning of the distance value may vary according to the embodiments. For example, in one embodiment, the distance value takes the form of a numerical value describing the position the word in a list of words representing synonyms or antonyms. In another embodiment, the distance value describes a measure of importance. The distance value describes the words position in list of such words and includes a measure of relevancy consistent with the usage of the aforementioned word. It should be noted that synonym and antonym words may themselves have synonyms 512 and antonyms 518 that in turn may have further synonyms and antonyms.

The texts 520, 522, 524, 526, 532, 534, may be considered SPAM by one particular recipient, not SPAM by a different particular recipient and neither SPAM or not-SPAM by another particular recipient. Furthermore, the texts 520 and 522 and the texts 524 and 526 without the context of other encapsulating text may be considered dissimilar or similar resulting in the incorrect SPAM detection by a particular embodiment. For example, text 520 does not define what it is “lower than” and the implication that text 524 is the same as text 526 is only broken when a specific value is assigned to the word “cost” in 526. In preferred embodiments, context is applied to such texts demonstrating that they are contextually similar but are not to be treated as equivalents. Word Store 530 is used to store such data as is required to describe a word or a sequence of words of which 520 is an example and such contextual relevancy and abstract information used by the specific embodiment. For example, one embodiment stores individual words with no synonyms and antonyms. Another embodiment stores the word and data describing its context. Some embodiments store the word or text sequence, data describing its usage relevancy and context, such synonyms and antonyms and abstract information as appropriate in addition to the date and time the word was first used, the number of times the word was referenced and the date and time the words was last references. Clearly the nature and quantity of such information differs among specific embodiments and should in no way be considered restricted to these described examples.

Each root word 508, 538 in the store 530 has a list of equivalent synonyms 542 comprising the synonym and a pre and post usage operator defining its context and a list of antonyms 546 comprising the antonym and a pre and post usage operator defining its context. Preferred embodiments use a time-to-live (TTL) value to remove seldom used words by checking the TTL value against the date and time that the word was last used in addition to removing words with a low frequency of access. In some particular applications, preferred embodiments use Adaptive Storage (as described for example in PCT publication No. WO 01/63486) so that the most frequently encountered words are at the top of the store and the least frequently encountered at the bottom.

The specific words and terms stored in the word store 530 differs among specific embodiments, but preferred embodiments store specific words such as 508 and the texts such as 520.

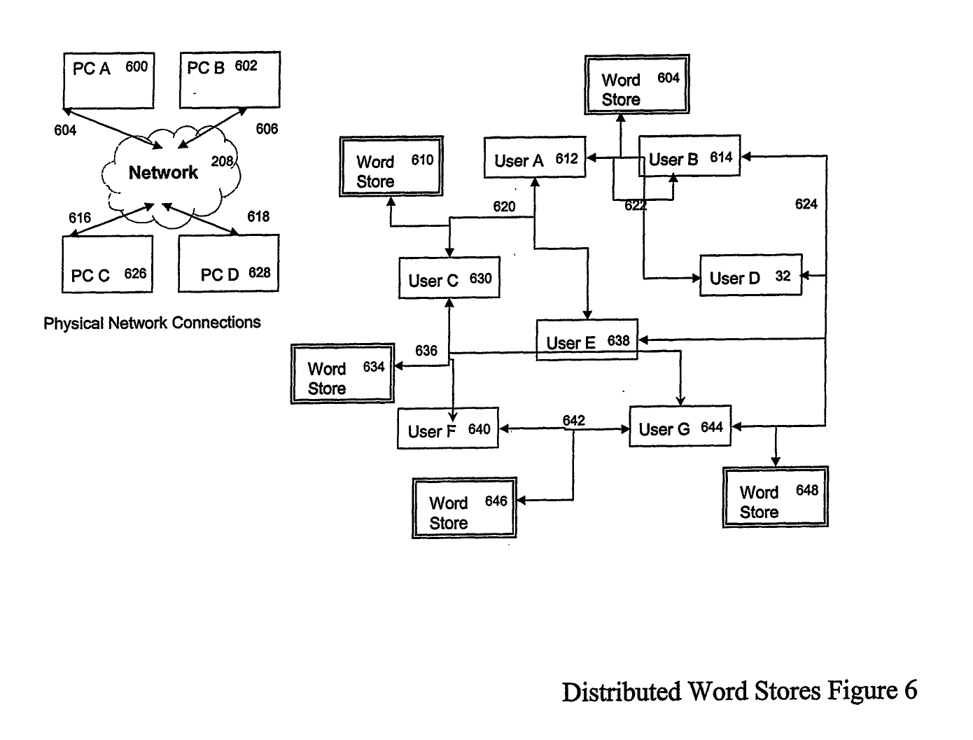

Some embodiments use the word store as the “good” and “bad” word corpus in deterministic detection techniques such as Bayesian filtering. Preferred embodiments employ a plurality of corpus (28) each containing a single or plurality of word stores (36, 40, 44) defining a plurality of categories, shared between pluralities of users of similar, dissimilar or indeterminate interest distributed across multiple computers on a network. Reference to FIG. 6 shows four PC's 600, 602, 626, 628 joined together. Terms such as “corpus” and its plural form “corpora” are used to categorize specific abstract text and data into specific sets containing text and data of determined relevancy.

Preferred embodiments also provide for the identification of words and terms that are not part of a particular or a plurality of natural languages by storing words and terms known to be in usage in singular or plurality of words stores.

People share information by constantly forming data connections with others of similar interests and with those with desired information. An example of such a connection would be “conversations” where pluralities of peoples exchange information, people entering and leaving the conversation in accordance with their specific and particular needs. Data contained in deterministic corpora are dependent on the specific data used to build the corpus and vary between the specific needs of the particular user. Further reference to FIG. 6 shows a network of users A (612), B (614), C (630), D (632), E (638), F (640), G (644) sharing specific and possibly differing data in email conversations 620, 622, 624, 636, 642. The data should no way be considered restricted to email nor should the nature and number of data conversations be considered restricted to that of this example. Word stores 604, 610, 634, 646, 648 are shown associated with data conversations 620, 622, 624, 636, 642 such that a single or plurality of users have access to a single or plurality of Word Stores the content of the aforementioned stores being available to those users connected to the store. The connections between data conversations and word stores should not be considered restricted to that shown in FIG. 6. Other configurations such as a singular or plurality of data conversations connected to a plurality of or single word stores are possible and should be expected. The network paths interconnecting the users, their data conversations and the word stores vary between embodiments and should not be considered restricted to any particular network topology or Space environment. The number of possible connections is dependent upon the number of users, data conversations and word stores as required by the needs of the specific embodiments. In one example, the user, data conversations and word stores are all located on a single server such as a Mainframe. In another example, user and data conversations are on a single local network. In another example the users, data conversations are distributed across multiple machines and multiple networks the Internet being such an example. Preferred embodiments will use distributed Space networks and Adaptive Stores and example of which can be found in PCT Publications WO 01/63486 and WO 03/005224A1.

Attention is now drawn to an aspect of the current invention that forms distributed knowledge corpora across distributed networks of computers and users. Although the type of network and distribution will vary between embodiments and should in no way be limited to this example, preferred embodiments would use a network such as Java Space by Sun Microsystems, would join such Spaces across non heterogeneous networks such as described in PCT Publication number WO 03/005224A1.

Attention is now turned to another aspect of the present invention that collaborates specific data sets such as Corpora and Email Source Data between a plurality of users communicating together across a network and specifically across a Space and Joined Space environment.

Reference to FIG. 7 shows a distributed network space cells A (702), B (718) and C (726) joining data levels such that connections J1(708) interconnects A (702) with B (718), J2(716) interconnects B(718) with C(726) and J3(728) interconnects C(726) with B(718) although the specific number and nature of such interconnections is dependent on the embodiments and should in no way be considered limited to this example. Space Cells A, B and C also have Email Source Data associated with them such that Space Cell A (702) is associated with Email Source Data 704, Space Cell B (718) is associated with Email Source Data 14 and Space Cell C (726) is associated with Email Source Data 732. The term “associated” is used broadly and not restrictively to mean that the Email Data Source is connected to or physically contained within the Space Cell the nature of such connection and containment being determined by the embodiment and should in no way be considered restricted to that described herein. In one embodiment, the Email Source Data is contained within the system providing the Space Cell. In another embodiment the Email Source Data is contained within a system connected to the Space Cell by a network connection. In another embodiment the Email Source Data is not present in the Space Cell. Some embodiments provide for the containment of the Email Source Data within the Space Cell such that it can be accessed as part of a single or joined space environment and also stored on a single or plurality of storage external to the Space Cell. Particular attention is drawn to the ability of each Space Cell (702, 714, 726) to continue to function after becoming detached from a single or plurality of other Space Cells or users.

While FIG. 7 shows specific numbers of Space Cells, Email Source Data and Corpus and example connections, the number of such Space Cells, Corpus and Email Source Data and connection therein is practically unlimited. In no way should the number and nature of users connected to A(702), B(718) and C(726) and the duration which these users are connected be considered limited to this example as such numbers and connection times are limited only by practical constraints and the abilities of the embodiments.

Returning attention to FIG. 7, data corpuses (700, 706, 710, 712, 720, 722, 724, 730) falling into categories Legal, Production, Scientific and Accounts reflecting their bias towards data relevant to the needs of each of these respective disciplines. In one example, the legal Corpora would comprise a word store of legal words and legal terms deemed “wanted” and another word store of words and terms that were not relevant and therefore “unwanted” in a legal context. Attention is drawn to word store operation and words and terms that are neither “wanted” nor “unwanted” in other Figures.

Turning attention to Space Cells B (718) and C (726) we see that corpora 730 and 716 have the same relevancy (i.e Scientific) are shared between users of Space Cells B (718) and C (726) by J3 (728). Although shown as corpora of like relevancy, merging data between dissimilar corpora may be required by some embodiments and the merging of corpora should in no way be considered limited only to corpora of similar or dissimilar content.

Particular attention is drawn to the data accessible from Space Cell B (718), which directly access Corpus 710, 712, 714 and 722 and indirectly access Corpuses 730, 720 and 706 via synchronizers J1, J2 and J3. Since the data contained in the Corpuses 706, 720, 722 is dependent upon the specific usage and interests of the single or plurality of users connected to Space Cells 702, 718, 726, combining corpus information for users of like interests would clearly benefit such users.

Attention is now turned the merging and comparison of corpus information (FIG. 6 and FIG. 5) and Email Source Data (FIG. 4). Combining such information gives rise to problems specific to the nature of the data. Considering Corpora, if Corpus 712 contains 10 words and Corpus 706 contains 20 words merging the two together could take (10 * 20)+(20 * 10)=400 operations, the number of such operations being dependent on the number of Corpus being merged, the number of words in each corpus being merged, the specific nature of the Space Cells A, B and C and the specific embodiments. Those versed in the art will be aware of techniques to merge such lists and will know that the number of potential operations will increase in close proportion to the number of words and the number of Corpora. For example, if Corpus 712 (termed CA) contains 100,000 words, Corpus 706 (termed CB) contains 50,000 words and Corpus 720 (termed CC) contains 20,000 words, dependent upon the specific embodiment, the total number of operations could be:
2(CA*CB+CA*CC+CB*CC)=2*(100,000*50,000+100,000*20,000+50,000*20,000)=16,000,000,000

With further reference to FIG. 4, combining a plurality ‘n’ of Email Source Data similarly involves a total number of operations consistent with the number of lists and the number of lists members in each of the Email Source Data. For example, if one Email Source Data “x” contains 2 members “x1” “x2” in the list 418 and x1L (402) contains x1L name pair elements and x2 (420) contains x2L name pair elements and another Email Source Data “y” contains 2 members “y1” “y2” in the list 418 and y1 (402) contains y1L name pair elements and y2 (420) contains y2L name pair elements, dependent upon the specific embodiment, the total number of operations would be:
N* (X1L*y1L)*N) Where N is the total number of lists 402.

The exact number of operations may depend upon the specific embodiment but it is clear that the number of such operations could become extremely large and exceed the abilities of the embodiment or fall outside the expectations of a particular user. If for example a particular embodiment can process 10,000 list operations per second, it could take less than a second to process Email Source Data elements but (from the above example) 16,000,000/10,000=1,600,000 seconds, or over 18 days to process Corpora.

Corpus and Email Source Data represent “data collections” pluralities of data collections of like nature can combined together, For example, a plurality of Corpus can be combined and a plurality of Email Source Data can be combined but although possible in practice, combining a single or plurality of Corpus with a single or plurality of Email Source Data might only be of interest to a particular embodiment.

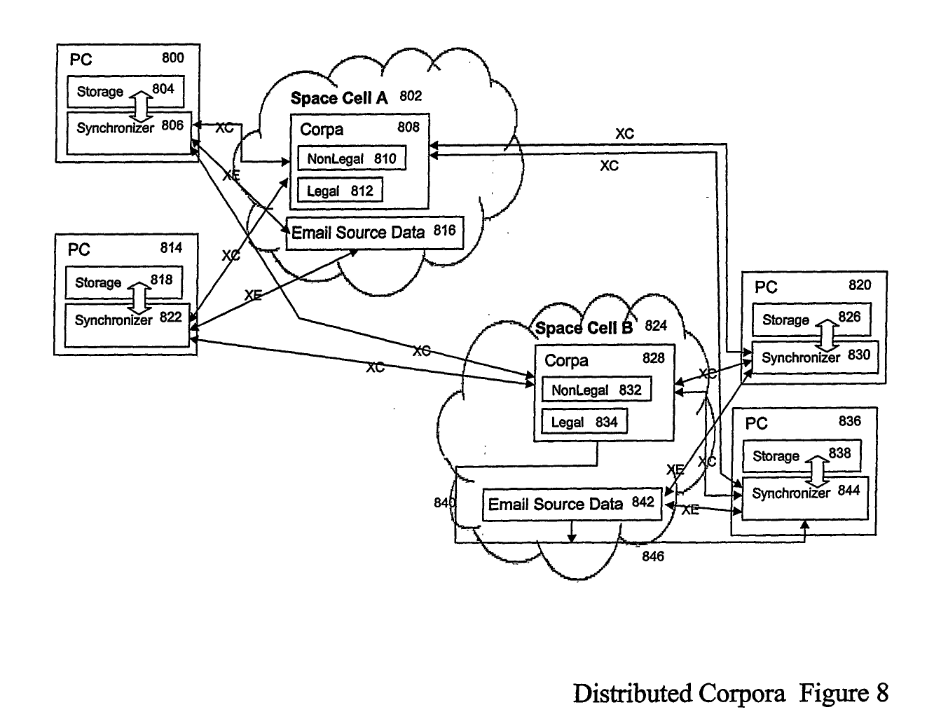

Reference to FIG. 8 shows the way in which Data Collections are combined and although we are considering a Data Collection as containing solely Corpus or solely Email Source, other data types capable of being merged are possible and this example should in no way be considered restricted or limited to specific data constructs.

Reference to FIG. 8 shows the data connections by which data is accessed from a corpus and synchronized with a plurality of other corpuses and the data connections by which data is accessed from a Email Source Data and synchronized with a plurality of other Email Source Data PC's 800 and 814 accessing a plurality of Corpus 808 and a plurality of Email Source Data (816) in Space Cell A (802) from Synchronizers 806 and 822. PC's 820 and 836 accessing a plurality of Corpus 828 and a plurality of Email Source Data (844) in Space Cell B (824) from Synchronizers 830 and 846.

Although PC's are used in this example, any device capable of data storage, communication with a Space Cell and the processing of data may be used and should in no way be considered restricted to the PC's used in this example. In one example, the PC would take the form of a wireless handheld device. In another example, the PC would take the form of terminal connected to a Mainframe. The way in which a plurality of Corpora data is combined will vary between embodiments and should in no way be considered limited to these examples.

Attention is turned specifically to the way in which data is shared and combined between Spaces 802 and 824 and Storage 804, 818, 826 and 838. Synchronizers 806, 822, 830 and 844 have connections XC to Corpora such that 806 and 822 connects to Corpora 808 and 824 and 844 connect to Corpora 828 and Synchronizers 508, 528, 532 and 542 have connections XE to Email Source Data such that 508 and 528 connects to Email Source Data 812 and 830 and 844 connect to Email Source Data 842. Relative to the Synchronizers, Email Source Data and Corpus data held within space can be considered similar enough to be transported in the same way and merged in accordance with the specific data and needs of the embodiments. Admittedly only data of like type should be merged and combined such that a plurality of Corpora are merged together and a plurality of Email Source Data are merged together but merging singular or a plurality of Corpora and Email Source Data might be impossible or give rise to unusable results in some embodiments.

Paying particular consideration to Corpus Data, receiving a request for a word or word term “W” Synchronizer 806 requests W from Storage 804 which responds with data “DS”, Corpora 808 which responds with data “DC1 ” and Corpora 828 which responds with data “DC2”. The nature of the requests made by Synchronizer 808 will vary between embodiments but some embodiments will use treat Space Cells 802 and 824 as distributed Space networks examples of which can be found in PCT Publication Number WO/03/005224A1. Attention will now be turned to example Synchronizer requests and their implications. In one example, the Synchronizer requests corpus entry ‘W’ from a plurality of Storage ‘Ns’ and a plurality of Corpora connected across a plurality of networks ‘Nn’ and a plurality of distributed Space environments ‘Nds’. After a time period ‘t’, the Synchronizer receives
(Ns−RNs)+(Nn−Rnn)+(Nds−RNds) corpus entries where:
Rns<=NS and Rnn<=Nn and RNds<=Nds.

For example, if a Synchronizer requests ‘W’ from a total of 10 Corpus, it might receive fewer than 10 data ‘W’ entries. In another example, a Synchronizer will receive more than 10 data ‘W’ entries. The number of data items received and the time taken to receive such entries is dependent on the embodiments and should in no way be considered restricted to the examples herein. Whether a Synchronizer waits to receive all or some of the requested Corpus entries and if the full or partial Corpus synchronization is required is dependent on the embodiment. In one embodiment, the Synchronizer waits for a particular time period and uses whatever replies have been received. In another embodiment desiring data synchronization between corpora, the request to the Synchronizer will fail if all of the replies have not been received within a particular time period. However, since the number and nature of the data paths (XY) can change and are potentially unknown at any instant in time, some embodiments will synchronize replies received within a particular time period enabling possibly unknown or shortly-to-be-created data paths from other Synchronizers to access the new data. Admittedly such synchronization will result in differences in the requested value “W” between those Corpora that responded and those that did not. A similar such situation might arise if merged data cannot be written back to a single or plurality of corpus. Consider an example where an item W was requested from “N” corpora and that “R” data entries were received after time period Treq resulting in (N-R) data being merged from (N-R) sources and written to the responding (N-R) corpora. Consider now an example where data item ‘W’ was requested from and replies received by a plurality ‘N’ of Corpora (Set-A) but merged data could only be written to a smaller plurality R, the total number of deprecated Corpora would be (N-R). Such failures are commonplace and should be expected in distributed environments such as Joined Space and networks such as the Internet. Consider further that a subsequent request for data item “W” is requested from the Corpora comprising Set-A and replies received from all members of Set-A, we will have R corpora in Set-A with potentially different data than compared with N-R corpora from Set-A. However, if N-R is merged with R and R is merged with N-R to form the set “Merge-A” which is then successfully written to all corpora in Set-A, all Corpora are re-synchronized. Even if all members of Set-A were not updated with the newly merged information, that that were would result in a constant average, the age and accuracy being dependent on, but in no means limited to, such factors as network reliability, machine reliability, network speed, the time duration the embodiment is prepared to wait for replies and the periodicity that the data item ‘W’ is accessed. If ‘W’ is accessed frequently, the corpora have a greater probability to completely synchronize to the updated information and conversely the less frequently ‘W’ is accessed, the lower the probability of the corpora being synchronized. Some embodiments would employ multiple alternate data paths between Corpora maximizing access probability. Drawing attention to the effects of seldom used words that have suffered previous synchronization failure, it can be seen that a particular access offers a chance for such synchronization to succeed. Drawing attention to the specific case where for example Space Cell C,726 in FIG. 7 becomes detached from Space Cell A (702) and Space Cell B (718), it still has a copy of corpora 720 and 730. In the event Space Cell B (718) is reconnected to Space Cells 702 and 726 or to other previously unconnected Space Cells, the re-synchronization process will resume.

The number of entries W that a corpus can contain is dependent on the size of the entry and the abilities of the embodiment. For example, in one embodiment such as a cell-phone, storage is limited and few entries are possible whereas storage could be plentiful in another embodiment such as a Personal Computer. Clearly however, the storage could be entirely consumed and some embodiments provide for the removal of unused or infrequently used corpus entries. In one example, a process is run periodically to examine all corpus entries and to take appropriate action on those that are deemed to be unwanted: it should be noted that the time taken to perform such a process can be considerable and is dependent on the number of entries and the abilities of the embodiment. Another example examines some, all, or a plurality of corpus entries when a particular entry is accessed although admittedly with the drawback that some seldom used or unwanted entries could be missed. Some embodiments employ adaptive storage an example of which is PCT Publication Number WO 01/63486 to segregate less frequently accessed data items from more frequently accessed items enabling appropriate action (such as removal) to be taken on the aforementioned segregated items.

Specific attention is drawn to the way that the Corpus 528 and Email Source Data 540 notify Synchronizer 542 when the Corpus 528 and Email Source Data 540 have been accessed. For example, in one embodiment, Synchronizer 542 received a notification when data is written either to Corpus 528 or Email Source Data. In another embodiment Synchronizer 542 receives a notification when data is deleted from Corpus 528. In another embodiment, Synchronizer 542 receives a notification when any access is made to Corpus 528 and Email Source Data 540. Synchronizer 542 upon receiving such notification takes action consistent with the needs of the specific embodiment. One example embodiment upon receiving notification that a data item ‘W’ has been written to either Corpus 528 or Email Source Data 540, synchronizes this data with Storage 538 and any other accessible Corpora or Email Source Data such as those in other connected Space Cells.

Although the preceding discussion specifically refers to the synchronization and merging of Corpora, the methods previously described should in no way be considered limited to Corpora and apply equally to Email Source Data previously described and can be applied without restriction to any data set.

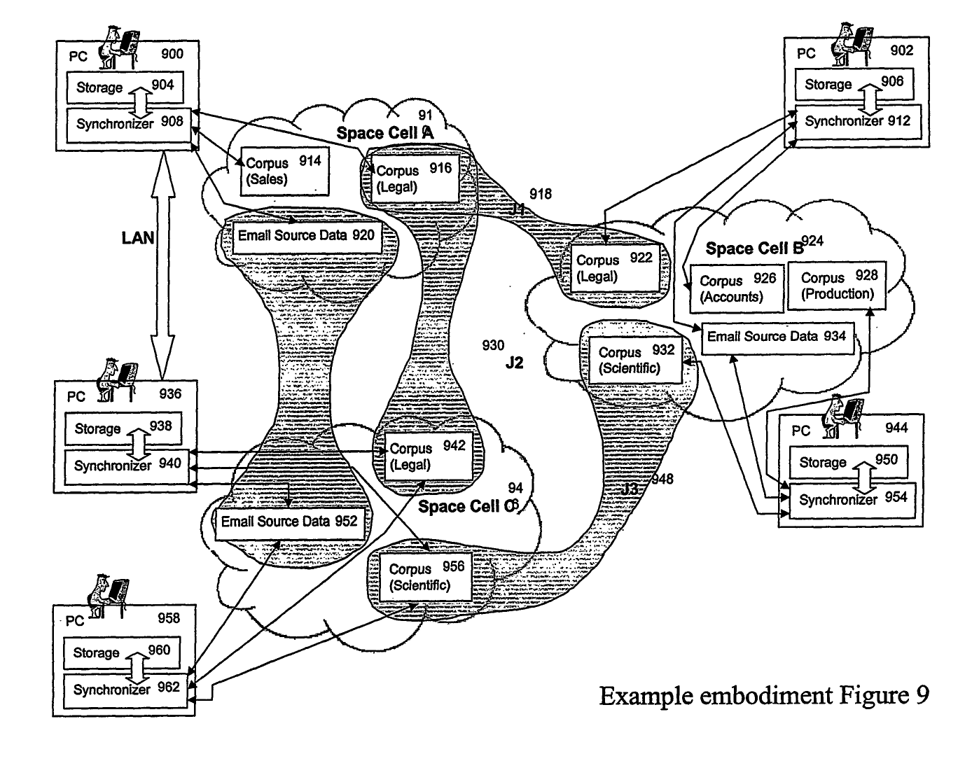

Attention is now turned to an example embodiment in FIG. 9 where users of PC's 900, 902, 936, 944 and 958 connect to Space Cells 910, 924, 946. PC's 900 and 936 and are directly connected to each other via a LAN connection. The number of users, number of PC's and number of Space Cells is limited only by the requirements and abilities of the specific embodiments and should not be considered limited to that in this example. Emails received by the PC's are analyzed to produce Email Source Data and entries for such Corpus as are dictated by the interests of the particular user and stored in Storage. The Email Source Data and Corpus Data are merged into that contained within the Space Cells via the Synchronizers. For example, an email received by PC 900 is analyzed to produce Email Source Data that is compared against previously encountered Email Source Data in Storage 904 and 920 via Synchronizer 908 to determine if the email has previously been received and if the email has been masqueraded by a source other than that described by the emails “from” address. The email contents and optionally the contents of the emails headers are incorporated via Synchronizer 908 into Corpora 916 and 914 and analyzed to determine if the aforementioned email is of a similar nature to the Sales Corpus (914) or the Legal Corpus (916), of no interest to the user of PC 900 or if it is to be considered SPAM, PC 900 taking appropriate action. Particular attention is drawn to Corpus 916 is merged with Corpus 942 in Space Cell B (924) and Email Source Data 920 that is shared with Email Source Data 952 in Space Cell C (946). Note particularly that the sequence of operations to write Corpus and Email Source Data to the store is identical in this example embodiment such that the operations apply equally to Corpus Data and Email Source Data. For example, comparing the textual elements in the content of a received email requires comparison with the textual elements in the relevant Corpora by reading existing content and in some instances the writing of data to the relevant Corpora Reading or otherwise accessing an item “W” from a single Corpus or a plurality of Corpora is performed by the Synchronizer with the example sequence of operations:
a) read “W” from Storage 904—the read item will be termed “LW”
b) read “W” from Corpus 916—the read item will be termed “CW_d”
c) read “W” from Corpus 922 the read item will be termed “CW 1”
d) combine LW, CW_d and CW_1 as previously described—termed “Wtot”

Synchronizer 908 performs the following steps to write Corpus data to local Store 904, Corpus 916 and Corpus 942:
a) write data to storage 904
b) write data to Corpus 916
c) write data to Corpus 942
d) synchronize the contents of corpus data in Storage 908, 916 and 942.

Similarly, Synchronizer 908 performs the following steps to write Email Source Data to local Store 904, Email Source Data 920 and Email Source Data 952:

e) write data to storage 904
f) write data to Email Source Data 920
g) write data to Email Source Data 952
h) synchronize the contents of Email Source Data in Storage 908, 920 and 952.

If for some reason Space Cell 910 becomes detached from Cells 924 and 946, the write operations to 910 and Storage may still succeed and the user of PC 900 will still benefit from data previously synchronized from Email Source Data 952 and Corpus 942. In the event that PC 900 becomes detached from Space Cell 910, the user of PC 900 still benefits from the data previously synchronized from Email Source Data 952 and Corpus 942 contained in Storage 904. With particular consideration to the data conversation connection between Corpus 916 and Corpus 942 and the data conversation connection between Corpus 942 and Corpus the user of PC 900 will in fact be benefiting indirectly from the corpus data in 922 since it is combined with the data in Corpus 942 via Synchronizer 940.

Admittedly there is no direct data conversation between Corpus 916 and 942 but the data in 916 could have been previously merged with data in Corpus 942 as a result of, for example, a previous read or write operation.

1. (canceled)

2. A method of characterizing an e-mail to a recipient received at a destination, comprising:
processing information associated with the received e-mail in view of information associated with the recipient; and
determining from a result of the processing step a probability, on a continuum of probabilities, that the recipient is interested in the received e-mail.

3. The method of claim 2, wherein:
the information associated with the received e-mail includes word content of the received e-mail.

4. The method of claim 3, wherein:
the information associated with the recipient includes word content associated with the recipient.

5. The method of claim 4, wherein:
the word content associated with the recipient includes word content associated with one or more interest groups with which the recipient is associated.

6. The method of claim 2, wherein:
the information associated with the received e-mail includes path information associated with the received e-mail.

7. The method of claim 6, wherein:
the information associated with the recipient includes path information of previously-received e-mails associated with the recipient.

8. The method of claim 7, wherein:
the previously-received e-mails associated with the recipient include e-mails previously received by recipients in one or more interest groups with which the recipient is associated.

9. The method of claim 7, wherein:
the path information associated with previously-received e-mails, associated with the recipient, includes an indication of unique paths associated with the previously-received e-mails and statistics regarding previously-received e-mails nominally received via the unique paths.

10. The method of claim 9, wherein:
the unique paths associated with previously-received e-mails include IP addresses.

11. The method of claim 10, wherein:
at least some of the IP addresses are resolved using at least one IP address lookup service.
